(19) United States
(12) Patent Application Publication
(10) Pub. No.: US 2025/0306748 A1
(43) Pub. Date: Oct. 2, 2025

(54) PROCESSING METHODS AND ELECTRONIC DEVICE

(71) Applicant: Lenovo (Beijing) Limited, Beijing (CN)

(72) Inventors: Binqiang MA, Beijing (CN); Bingyu HUANG, Beijing (CN)

(21) Appl. No.: 19/094,565

(22) Filed: Mar. 28, 2025

(30) Foreign Application Priority Data
Mar. 31, 2024 (CN) 202410384312.0

(51) Int. Cl. G06F 3/04845

(52) U.S. Cl. CPC G06F 3/04845; G06F 2203/04806

(57) ABSTRACT

A processing method applied to a first device includes obtaining first image information; determining an image display area based on the first image information, an size of the image display area being larger than a size of a first image corresponding to the first image information, and an area of the image display area being smaller than or equal to a first screen of the first device; and outputting a display image based on the image display area and the first image information, the display image including the first image.

### CROSS-REFERENCE TO RELATED APPLICATION

This application claims the priority of Chinese Patent Application No. CN2024103843120, filed on Mar. 31, 2024, the entire content of which is incorporated herein by reference.

### FIELD OF THE DISCLOSURE

The present disclosure generally relates to the field of computer technology, and more particularly to a processing method and an electronic device.

### BACKGROUND

Screen projection technology is a technology that can project an image displayed on a screen of an electronic device onto another electronic device. With the development of technology, screen projection technology can not only realize image projection, but also realize operation mapping between devices. For example, when the content of a mobile phone screen is projected to a computer, an operation of the computer on a projection screen can be mapped to the operation of the mobile phone screen, so that the computer can control the mobile phone. Since the projection screen is generally displayed in the form of a window, it is easy to cause incorrect operations when operating electronic devices through projection. For example, when projecting the mobile phone screen on the computer, when a user slides left and right from the screen border to realize the page turning function on the projection window of the computer, it is easy to trigger a zoom function of the window, or it is easy to position a mouse outside the projection window when touching the screen, resulting in the operation being invalid for the projection window.

### SUMMARY OF THE DISCLOSURE

One embodiment of the present disclosure provides a processing method applied to a first device. The method includes obtaining first image information; determining an image display area based on the first image information, an size of the image display area being larger than a size of a first image corresponding to the first image information, and an area of the image display area being smaller than or equal to a first screen of the first device; and outputting a display image based on the image display area and the first image information, the display image including the first image.

Another embodiment of the present disclosure provides an electronic device. The electronic device includes one or more processors; and a memory in communication with the one or more processors and containing instructions that, when being executed, cause the one or more processors to perform: obtaining first image information; determining an image display area based on the first image information, an size of the image display area being larger than a size of a first image corresponding to the first image information, and an area of the image display area being smaller than or equal to a first screen of the first device; and outputting a display image based on the image display area and the first image information, the display image including the first image.

Another embodiment of the present disclosure provides a non-transitory computer readable storage medium containing instructions that, when being executed, cause at least one processor to perform: obtaining first image information; determining an image display area based on the first image information, an size of the image display area being larger than a size of a first image corresponding to the first image information, and an area of the image display area being smaller than or equal to a first screen of the first device; and outputting a display image based on the image display area and the first image information, the display image including the first image.

### BRIEF DESCRIPTION OF THE DRAWINGS

The following drawings are merely examples for illustrative purposes according to various disclosed embodiments and are not intended to limit the scope of the present disclosure.

In order to more completely understand the present disclosure and its advantages, reference will now be made to the following description in conjunction with the accompanying drawings, wherein:

FIG. 1 schematically illustrates an application scenario of a processing method and a processing device according to one embodiment of the present disclosure;

FIG. 2 schematically illustrates a flow chart of a processing method according to one embodiment of the present disclosure;

FIG. 3 schematically illustrates a flow chart of a method for determining an image display area according to one embodiment of the present disclosure;

FIG. 4 schematically illustrates a flow chart of a method for outputting a display image according to one embodiment of the present disclosure;

FIG. 5A schematically illustrates a schematic diagram of an output display image according to one embodiment of the present disclosure;

FIG. 5B schematically illustrates a schematic diagram of an output display image according to one embodiment of the present disclosure;

FIG. 6 schematically illustrates a flow chart of a method for determining a second image size according to one embodiment of the present disclosure;

FIG. 7 schematically illustrates a method for interaction between a first device and a second device according to one embodiment of the present disclosure; and

FIG. 8 schematically illustrates a schematic block diagram of an electronic device according to one embodiment of the present disclosure.

### DETAILED DESCRIPTION

Reference will now be made in detail to exemplary embodiments of the disclosure, which are illustrated in accompanying drawings. Wherever possible, same reference numbers will be used throughout drawings to refer to same or like parts. In the detailed description below, for ease of explanation, many specific details are set forth to provide a comprehensive understanding of embodiments of the present disclosure. However, it is apparent that one or more embodiments may be implemented without these specific details. In addition, in the following description, descriptions of known structures and technologies are omitted to avoid unnecessary confusion of concepts of the present disclosure.

Terms used herein are only for describing specific embodiments and are not intended to limit the present disclosure. Terms “include”, “comprising”, etc. used herein indicate the existence of features, steps, operations and/or components, but do not exclude the existence or addition of one or more other features, steps, operations or components.

All terms (including technical and scientific terms) used herein have meanings commonly understood by those skilled in the art unless otherwise defined. It should be noted that terms used herein should be interpreted as having a meaning consistent with the context of this specification and should not be interpreted in an idealized or overly rigid manner.

In the description of this specification, the description of reference terms “one embodiment”, “some embodiments”, “examples”, “specific examples”, or “some examples” means that specific features, structures, materials or characteristics described in conjunction with the embodiment or example are included in at least one embodiment or example of the present application. Moreover, specific features, structures, materials or characteristics described may be combined in any one or more embodiments or examples in a suitable manner. In addition, those skilled in the art may combine and combine different embodiments or examples and features of different embodiments or examples described in this specification without contradiction.

In addition, terms “first” and “second” are used for descriptive purposes only and cannot be understood as indicating or implying relative importance or implicitly indicating the number of indicated technical features. Therefore, features defined as “first” and “second” may explicitly or implicitly include at least one of features. In the description of this application, “multiple” means two or more, unless otherwise clearly and specifically defined.

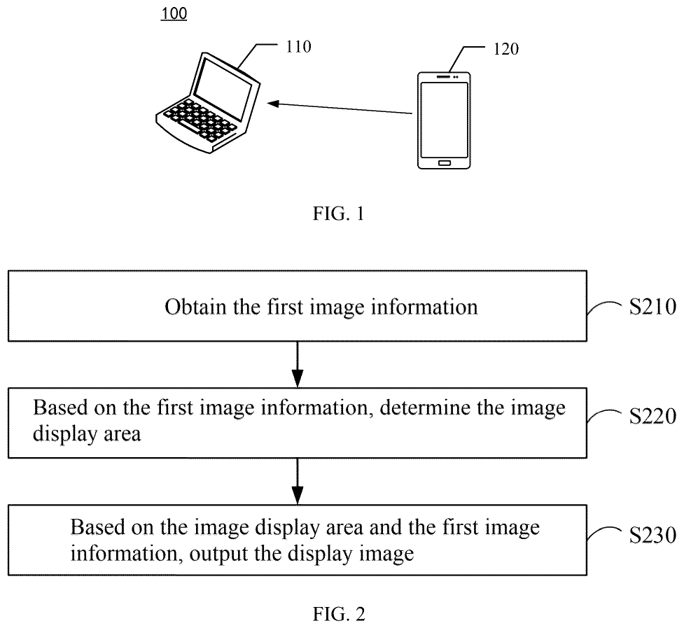

FIG. 1 schematically shows an application scenario 100 of an application running method and the application running device according to one embodiment of the present disclosure. It should be noted that FIG. 1 is only an example of a scenario in which the embodiment of the present disclosure can be applied, so as to help those skilled in the art understand the technical content of the present disclosure, but it does not mean that the embodiment of the present disclosure cannot be used in other devices, systems, environments, or scenarios.

As shown in FIG. 1, in the application scenario 100, a data channel is established between a first device 110 and a second device 120. Through the data channel, an image displayed on a screen of the second device 120 is projected onto the screen of the first device 110, so that a user of the first device 110 can see the screen content of the second device 120 and can control the screen of the second device 120 through the first device 110.

The first device 110 and the second device 120 may be various electronic devices with display screens, including but not limited to smartphones, tablet computers, laptop computers, and desktop computers, etc.

The user may use one of the first device 110 or the second device 120 to initiate a screen projection request to the other. After the request is approved, the two parties establish a wired or wireless connection and build a connection channel between the two so that the projection data can be transmitted through the connection channel.

After the connection channel between the first device 110 and the second device 120 is established, if the second device 120 obtains an operation related to screen projection, the second device 120 sends an instruction to the first device 110 to enable the first device 110 to enter the screen projection mode. For example, when the user performs screen projection operation through the second device 120 and sends a screen projection instruction to the first device 110, the first device 110 displays an animation effect of entering the screen projection mode on the screen, and starts to receive image information about the screen display of the second device 120 transmitted by the second device 120 through the data channel, and then displays the image of the second device 120 on a display screen of the first device 110 according to the image information. After the projection is completed, based on the data transmission of the data channel, the user can control the second device 120 on the first device 110 through the screen projection image.

In actual applications, Android screen projection/mirror software on Windows is usually displayed in a form of a window on the Windows side. As shown in FIG. 1, taking the second device 120 as a mobile phone and the first device 110 as a computer as an example, the screen window of the second device 120 is displayed on a desktop of the first device 110, and a title bar is provided above the screen window, and minimize, maximize and close buttons are provided in the title bar for reducing, enlarging or closing the window. When a computer user controls a mobile phone on a computer, it will simulate a mobile phone user clicking and sliding on the mobile phone screen. Since there is no screen border of the mobile phone on the computer, when the user implements control operations on the projection window of the mobile phone on the computer, it is easy to make mistakes or invalid actions. For example, when the mobile phone interface is pulled down from the top of the mobile phone screen, when the computer user slides down from the top of the projection window of the mobile phone, following problems are easy to occur: first, it is easy to click on the computer desktop, so that the actual operation object of a sliding operation becomes the computer desktop, resulting in invalid operation of the mobile phone; second, because an area of a drop-down page set by the mobile phone is at an edge of the top of the screen, it is difficult to accurately locate a preset area of the screen window on the projection window to implement the sliding operation, resulting in invalid operation; third, it is easy to accidentally touch preset buttons on the window, such as minimize, maximize, and close buttons.

Based on above problems, the present disclosure provides a processing method, which simulates the screen border of the mobile phone by adding a border area outside the projection window to improve the accuracy of the user's operation on the projection window. The processing method of the disclosed embodiment is described in detail below through FIGS. 2-7.

FIG. 2 schematically shows a flow chart of a processing method according to one embodiment of the present disclosure.

As shown in FIG. 2, the processing method is applied to a first device including a first screen, including operations S210 to S230.

In operation S210, first image information is obtained.

In one embodiment of the present disclosure, when the screen display content of the second device needs to be projected to the first device, a data channel is established between the first device and the second device, and first image information of the second device is transmitted to the first device through the data channel, so that the first device projects the screen on the first screen according to first image information.

In operation S220, based on first image information, an image display area is determined, the size of an image display area is greater than the size of the first image corresponding to first image information, and the area of the image display area is less than or equal to the first screen.

The image display area is the area of the first screen used to display a first image, wherein a position and a size of the image display area can be determined based on the size of the first screen. For example, the position of the image display area may be the upper left corner, upper right corner, lower left corner, lower right corner, or the center of the first screen, or any position that does not affect the display of the opened window on the first screen. The size of the image display area may be part or all of the size of the first screen.

In one optional embodiment of the present disclosure, the first image may be an image generated based on first image information and having the same display content and display size as the second screen of the second device, or may be an image after the image on the second screen is enlarged or reduced, so that the projection image of the second device can be displayed on the first screen of the first device with a preset size.

In one optional embodiment of the present disclosure, the first device may be an electronic device installed with a Windows system, and the projection image of the second device is displayed in the form of the window on the first screen of the first device, wherein the first image may be a window image, including the display content of the second screen of the second device generated based on first image information, and a border image including the window.

The area of the image display area is smaller than the first screen, the size of the image display area is larger than the first image, and the first image is displayed in the image display area, so that the first image can be fully displayed on the first screen.

In operation S230, based on the image display area and first image information, a display image is output.

The display image is an image output in the image display area of the first screen. The display image includes the first image. Since the size of the first image is smaller than the image display area, when the first image is displayed in the first display area of the image display area, since the first image is smaller than the image display area, there will be a second display area in the image display area, and the second display area can be displayed around the first image as a simulated screen border. Based on the second display area, when the user performs an operation close to the edge of the first image, it can be avoided that the desktop display area belonging to the first screen outside the first image is accidentally touched or the operation is mistakenly recognized as an operation on the projection image window.

Taking the first device as a computer and the second device as a mobile phone as an example, in some actual application scenarios, if the user needs to share files and information on the mobile phone, because the mobile phone screen is small and not suitable for sharing with multiple people at the same time, the user can project files and information on the mobile phone to the computer and share the information through the computer screen. According to the method provided by the embodiment of the present disclosure, the screen of the mobile phone is projected as the first image in the first area of the image display area of the computer screen, so that the projected image of the mobile phone is surrounded by the second area of the image display area, and a simulated mobile phone frame is formed around the projected image. When the user needs to turn pages in the projected image, the user can slide the computer cursor from the second area on left and right sides of the projected image to the projected image to simulate the left and right finger sliding on the mobile phone to turn the file.

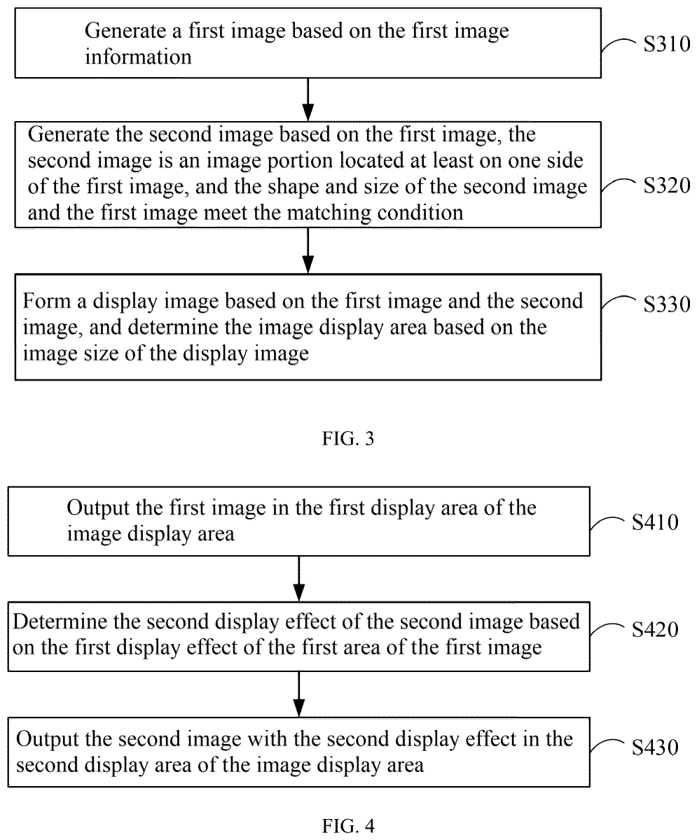

FIG. 3 schematically shows a flow chart of a method for determining an image display area according to one embodiment of the present disclosure.

As shown in FIG. 3, the method for determining the image display area provided by the embodiment of the present disclosure includes operations S310˜S330.

In operation S310, a first image is generated based on first image information.

First image information is data information related to the image displayed on the second screen of the second device when the second device projects the screen to the first device. Based on first image information, the first device can generate a first image displayed on the first screen. The first image includes a projected image of the second screen. When the first device is an electronic device installed with the Windows system, the first image may further include a window border image for outputting and displaying the projection image of the second screen in the form of a window.

In operation S320, a second image is generated based on the first image, the second image is an image portion located at least on one side of the first image, and a shape and a size of the second image and the first image meet a matching condition.

The second image is an image of a second display area other than the first display area where the first image is located, and is an image portion that is set on a side of the first image and has no substantial function. When the display image composed of the first image and the second image is output on the first screen, the shape and size of the second image and the first image meet the preset matching condition. The matching condition includes that the first image and the second image have the same shape and size at least in adjacent areas.

Taking the first image as a rectangular image as an example, an area where the second image is set can be one or more of the four rectangular areas on an upper side, lower side, left side and right side of the first image. For example, the first device is a computer, and the second device is a mobile phone. When the mobile phone is projected onto the computer, the screen of the mobile phone is displayed on the computer in the form of a window, wherein the second image can be set above, on the left side, below and on the right side of the window, and the second image is presented as a frame that widens the window frame, and the frame is rectangular with the rectangular window, and a length of each side is consistent with a length of the corresponding side of the window. The border has no substantial function. When the user operates at the edge of the window of the mobile phone projection screen, the second image can prompt the user to place the operation within the window. Optionally, the size and shape of the second image can be set on the first device.

In operation S330, a display image is formed based on the first image and the second image, and the image display area is determined based on the image size of the display image.

The image display area is the display area of the display image composed of the first image and the second image. According to sizes and shapes of the first image and the second image, the size and shape of the image display area on the first screen of the first device can be determined. For example, the first image is a circular image with a radius of 8 cm, the second image is a circular image with an inner diameter of 8 cm and a width of 1 cm, and the second image surrounds the first image, then the image display area can be determined as a circular area with a radius of 8.5 cm.

After determining the image display area and generating a display image based on the first image and the second image, one embodiment of the present disclosure further provides a method for outputting a display image.

FIG. 4 schematically shows a flow chart of a method for outputting a display image according to one embodiment of the present disclosure.

As shown in FIG. 4, the method for outputting a display image provided by one embodiment of the present disclosure includes operations S410 to S430.

In operation S410, the first image is output in the first display area of the image display area.

The first image may be a projection image of the second device. When the first image is displayed in the image display area of the first screen, the projection image may be directly displayed in the first display area, or a border or a special display effect may be selected at the edge of the first image and then displayed in the first display area, and the first image may be highlighted by the border or the special display effect.

In one optional embodiment of the present disclosure, the first device may display the projection image of the second device in a window through a projection program, so that the projection image has a clear boundary with other images in the first screen, so that the user can accurately distinguish the window. Optionally, the first device can also set the window to various colors or various display effects through the screen projection program. For example, the window can be set to bright colors such as black, white, red, blue, etc. to achieve the effect of beautifying the interface and enhancing the highlighting display. For another example, the window can be configured with various effect modes, such as transparent borders, special-shaped borders, simple borders, etc., to enrich the visual effect.

In operation S420, the second display effect of the second image is determined based on the first display effect of the first area of the first image.

Matching display effects of the first image and the second image can further enhance or beautify the visual effect of the displayed image. If there is a window border in the first image, the second image can be the same as a color, pattern and transparency of the window border, or at least one of the color, pattern, and transparency of the second image is different from the window border. If there is no window border in the first image, the second image can be an image that matches the color or transparency of the first image.

For example, assuming that there is a rectangular window border in the first image and the window color is white, the second image can be an image on left, bottom and right sides of the first image, each of which is a rectangle and white in color; or the second image can be an image on top, left, bottom, and right sides of the first image, each of which is a rectangle, no color is set, and the transparency of the second image is 50%; or the second image can be an image on the bottom side of the first image, the image color is white, and there is a diamond pattern.

For example, assuming that the first image has no window border, the second image is a ring pattern around the first image, the color is black, and a certain degree of transparency can be set to highlight the first image. Among them, when the transparency is adjusted to 100%, the second image is invisible, and the image actually displayed is only the first image.

In operation S430, the second image with a second display effect is output in the second display area of the image display area, and the second display area is the image display area on at least one side of the first display area.

The first image and the second image are output to form an integrated display image. Visually, the second image widens the border of the first image; functionally, the second image provides the user with more operable space near the edge of the first image. Optionally, the second image can not be displayed by adjusting the transparency, so that the border of the first image will not be widened visually, and the display effect of the first image displayed alone will not be affected.

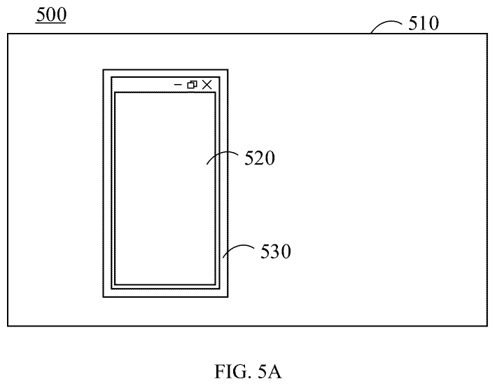

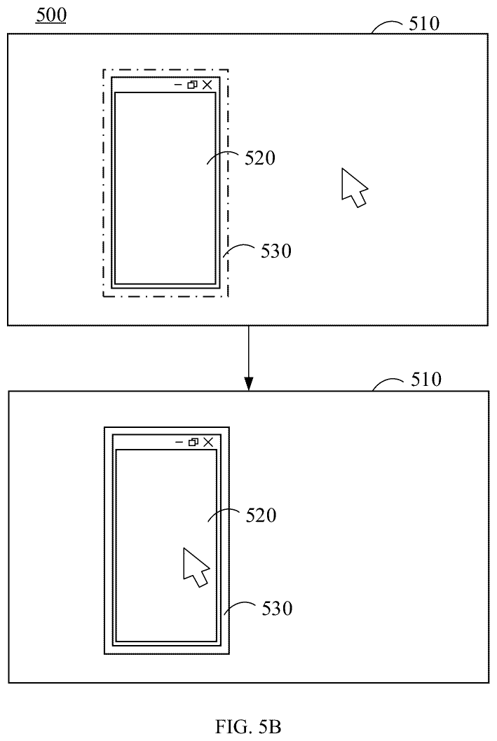

FIG. 5A schematically shows a schematic diagram of outputting a display image according to one embodiment of the present disclosure.

As shown in FIG. 5A, a screen image 520 of a mobile phone is projected onto a desktop 510 of a computer, and the screen image 520 is displayed in the form of a window. According to the processing method provided by the example of the present disclosure, when outputting the first image (i.e., the window image of the projection image 520 of the mobile phone), the second image 530 can be set in the image display area. The second display area where the second image 520 is located is an image area without substantial function. When the user performs an operation near the edge of the projection image 520, it can avoid accidentally touching the desktop display area belonging to the first screen outside the first image or the operation being mistakenly recognized as the operation on the projection image window.

Based on the method of outputting display images shown in FIG. 4, a dynamic display effect can also be added. The screen projection program of the first device can obtain a target display parameter representing the display state of the second image, and switch at least a part of the second image between a visible state and an invisible state based on the target display parameter. When the target display parameter satisfies the first condition, the second area of the second image is switched to an invisible state. The second area can be an image area where the second image is adjacent to the first image, or an image area where the second image is not adjacent to the first image. The second area can be a part of the second image, or the entire area of the second image.

The target display parameter can be a control parameter indicating whether the second image is visible or invisible. The control parameter can include a first control parameter and a second control parameter, the first control parameter is used to indicate that the second image is visible, and the second control parameter is used to indicate that the second image is invisible, and the first condition is that the target display parameter is the second control parameter. When the target display parameter is the second control parameter, the second image is hidden or the transparency is adjusted to invisible. When the target display parameter is the first control parameter, the second area of the second image is made invisible.

Further, the control parameter can be generated based on the user's first target operation. The screen projection program of the first device can switch the second area of the second image from an invisible state to a visible state in response to a first target operation in the image display area, and the first target operation is an operation performed on the second image. When the user performs the first target operation, if the first target operation is performed in the image display area, a first control parameter can be generated to control the second area of the second image to be visible; if the first target operation is performed in the non-image display area, a second control parameter can be generated to control the second area of the second image to be invisible. For example, if a mouse cursor is moved to the display image, the control parameter becomes the first control parameter, making the second area of the second image visible; if the mouse cursor is moved to a system desktop of the first screen, the control parameter becomes the second control parameter, making the second area of the second image invisible.

FIG. 5B schematically shows a schematic diagram of an output display image according to one embodiment of the present disclosure.

As shown in FIG. 5B, on the first screen of the first device, the system desktop of the first screen is displayed, wherein in the system desktop of the first screen, the first image of the second screen of the second device is displayed in a stacked manner, and the second image is arranged around the first image to expand the operable area of the first image for the user, and prevent the operation of the first image from accidentally falling on the system desktop of the first device or falling on the edge of the first image, resulting in an operation error. When the user's mouse cursor moves to the desktop of the first screen, a second control parameter can be generated based on the position of the mouse cursor to hide the second area of the second image, and expand the operable area on the desktop for the user, and the operable area includes the area where the second area is located before hiding; when the user's mouse cursor moves to the first image or the second image, a first control parameter is generated based on the position of the mouse cursor to fully display the second image, and help the user understand the operable area for operating the first image.

Based on above embodiments, one embodiment of the present disclosure further provides a method for determining the size of a second image.

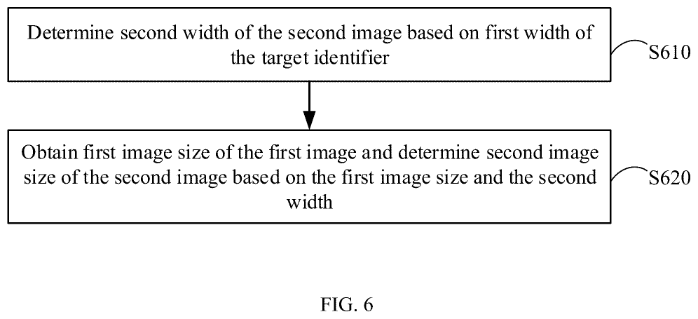

FIG. 6 schematically shows a flow chart of a method for determining the size of a second image according to one embodiment of the present disclosure.

As shown in FIG. 6, the method for determining the size of a second image provided by one embodiment of the present disclosure includes S610 to S620.

In operation S610, the second width of the second image is determined based on the first width of the target identifier, and the target identifier is an indicator symbol that guides the user to perform the first target operation in the second image.

The target identifier can be an indicator symbol such as a cursor. The indicator symbol can be a dot, an arrow, or the like. If the user wants to operate the second screen through the first screen, the user can use the target identifier as a guide to determine the location of the current operation.

When the user performs an operation based on the target identifier in the edge area of the first image, for example, the user simulates pulling down a hidden page on a mobile phone and needs to slide down from the second image to the first image, the width of the second image should ensure that the target identifier can be accommodated to perform the operation, otherwise the target identifier is easy to move out of the area where the second image is located. Therefore, the width of the second image needs to be determined according to the width of the target identifier.

In operation S620, the first image size of the first image is obtained, and the second image size of the second image is determined based on the first image size and the second width.

According to the first image size of the first image, the length of the side of the second image adjacent to the first image can be determined. For example, assuming that the first image is a rectangular image with a size of 15 cm×20 cm, the second display area is designed on upper and left sides of the first image to display the second image. For the sake of aesthetics, the second images on upper and left sides form an “L”-shaped image, so that the display image formed by the first image and the second image is a rectangular image, the left side length of the first image is 15 cm, and the upper side length is 20 cm. If the width of the second image is set to 2 cm, it can be determined that the length of the second image on the left side is 15 cm+2 cm=17 cm, and the length of the second image on the upper side is 20 cm+2 cm=22 cm. The method determines the width of the second image according to the width of the target mark, and determines the length of the second image according to the first image size of the first image, thereby obtaining the second image size.

According to the processing method provided in the above embodiment, by setting the first display area and the second display area in the image display area, using the second display area to simulate the screen border displayed around the first image, when the user performs the operation close to the edge of the first image, it can be avoided that the desktop display area belonging to the first screen outside the first image is accidentally touched or the operation is mistakenly recognized as the operation on the projection image window; by taking control measures such as display effect, visibility and size of the second image in the second display area, the display effect of the image is beautified or enhanced while ensuring the normal display of the image. Based on this processing method, it can help users to conveniently and accurately complete an interaction between the first device and the second device on the first device and realize remote control of the second device.

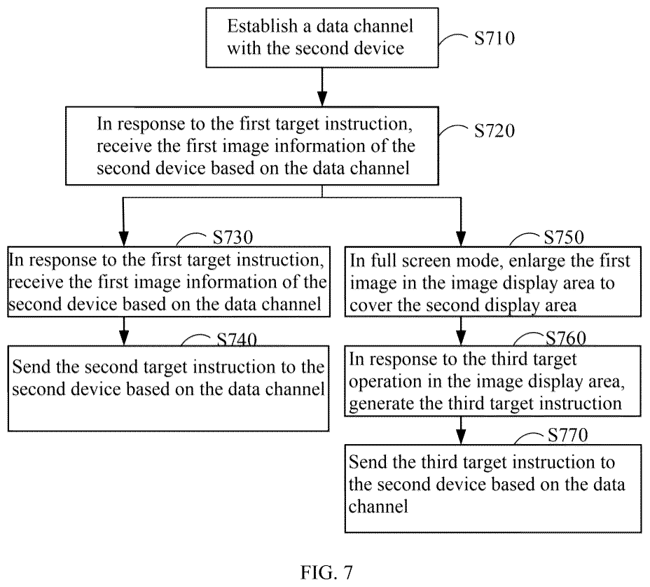

FIG. 7 schematically shows a schematic diagram of a method for interaction between a first device and a second device according to one embodiment of the present disclosure.

As shown in FIG. 7, the method for interaction between a first device and a second device provided in one embodiment of the present disclosure includes operations S710 to S720.

In operation S710, a data channel is established with the second device.

The first device includes a first screen, and the second device includes a second screen. When a user needs to project a screen image of the second device onto the first screen of the first device, the data channel can be established between the first device and the second device, and the data channel is used to transmit first image information of the second screen, and first image information is the image data displayed on the second screen.

In an optional embodiment of the present disclosure, the first device is a computer, and the second device is a mobile phone. The user can operate the mobile phone to send a screen projection request to the computer. When the computer user agrees to the screen projection request, Bluetooth components of the mobile phone and the computer are turned on, so that the mobile phone and the computer are paired by Bluetooth, and a data channel between the mobile phone and the computer is established based on a Bluetooth network.

Optionally, after the data channel between the first device and the second device is established, the data channel can be tested to verify whether the data channel can output data in real time, accurately, or stably. When the verification is passed, the user can be prompted that the current data channel has been built by the speaker of the first device and the second device, such as sound or screen display.

In operation S720, in response to the first target instruction, first image information of the second device is received based on the data channel.

After the data channel is built, the second device can send first image information to the first device. The first target instruction can be an instruction indicating that the data channel is built. When the data channel is built, the second device starts to send the first image data, and the first device starts to receive the first image data based on the first target instruction, so that the screen projection program of the first device outputs the display image in the image display area of the first screen according to the method shown in FIGS. 1-6.

As shown in FIG. 7, in one embodiment of the present disclosure, after the screen projection image of the second device is output on the first device, the interaction method between the first device and the second device can also include S730˜S740.

In operation S730, in response to the second target operation in the image display area, a second target instruction is generated.

The second target operation is an operation of sliding into the first image from the second display area of the image display area. The second display area is an image display area on at least one side of the first image. Based on the second display area, the second target operation can be prevented from being applied to places outside the image display area.

The second target instruction is used to instruct the second device to simulate the execution of the second target operation on the second screen. Taking the second device as a mobile phone as an example, if the second target operation is an operation of sliding from the second image on the right side of the first image into the first image, the second target instruction is a signal generated when the mobile phone system simulates a human finger sliding into the mobile phone screen from the right side of the mobile phone, or the second target instruction includes a signal generated when the simulated human finger slides into the mobile phone screen from the right side of the mobile phone.

In operation S740, the second target instruction is sent to the second device based on the data channel.

After the second target instruction is generated, the first device sends the second target instruction to the second device, so that the second screen of the second device simulates the execution of the second target operation, thereby displaying an operation interaction between the first device and the second device. Taking the second device as a mobile phone as an example, if the second target operation is to slide down from the top of the mobile phone desktop, then according to the second target instruction, the mobile phone system simulates the signal generated when a person's finger slides from the top of the mobile phone into the mobile phone screen, so that the mobile phone system displays the drop-down page of the mobile phone according to the signal.

As shown in FIG. 7, in one embodiment of the present disclosure, after the projection image of the second device is output on the first device, the interaction method between the first device and the second device may also include S750˜S770.

In operation S750, in full screen mode, the first image is enlarged in the image display area to cover the second display area.

In full screen mode, only the first image is displayed on the first screen. When the user operates on the edge area of the first image, the operation will not accidentally affect the display area of the first screen, and there is no need to set the second image or the second display area. The current image display area is the entire first screen, and the first image can be enlarged to cover the entire second display area, thereby increasing the display range of the first image.

In operation S760, in response to the third target operation in the image display area, a third target instruction is generated.

The third target operation is an operation of sliding into the first image from the second display area covered by the first image. The third target instruction is used to instruct the second device to simulate the execution of the third target operation on the second screen.

In operation S770, the third target instruction is sent to the second device based on the data channel.

According to the third target instruction, the first device can implement the operation of the second device in the second screen.

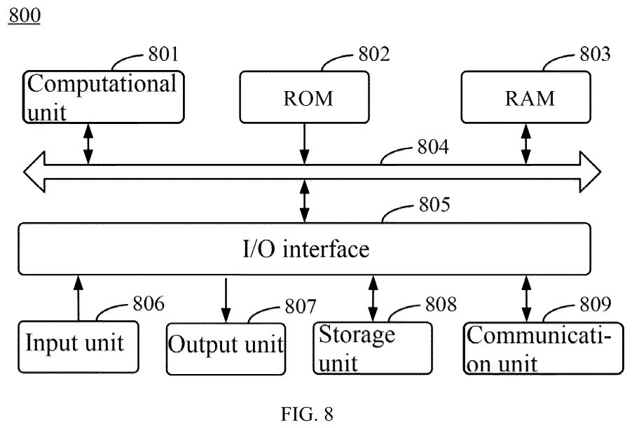

FIG. 8 shows a schematic block diagram of an example electronic device 800 that can be used to implement the method of the present disclosure embodiment. The electronic device is intended to represent various forms of digital computers, such as laptop computers, desktop computers, workstations, personal digital assistants, servers, blade servers, mainframe computers, and other suitable computers. The electronic device can also represent various forms of mobile devices, such as personal digital processing, cellular phones, smart phones, wearable devices, and other similar computing devices. The components shown herein, their connections and relationships, and their functions are merely examples and are not intended to limit an implementation of the present disclosure described and/or required herein.

As shown in FIG. 8, the device 800 includes a computing unit 801, which can perform various appropriate actions and processes according to a computer program stored in a read-only memory (ROM) 802 or a computer program loaded from a storage unit 808 to a random-access memory (RAM) 803. In RAM 803, various programs and data required for the operation of the device 800 can also be stored. The computing unit 801, ROM 802, and RAM 803 are connected to each other via a bus 804. An input/output (I/O) interface 805 is also connected to the bus 804.

Multiple components in the electronic device 800 are connected to the I/O interface 805, including: an input unit 806, such as a keyboard, a mouse, etc.; an output unit 807, such as various types of displays, speakers, etc.; a storage unit 808, such as a disk, an optical disk, etc.; and a communication unit 809, such as a network card, a modem, a wireless communication transceiver, etc. The communication unit 809 allows the device 800 to exchange information/data with other devices through a computer network such as the Internet and/or various telecommunication networks.

As shown in FIG. 8, the device 800 includes a computing unit 801, which can perform various appropriate actions and processes according to a computer program stored in a read-only memory (ROM) 802 or a computer program loaded from a storage unit 808 to a random access memory (RAM) 803. In RAM 803, various programs and data required for the operation of the device 800 can also be stored. The computing unit 801, ROM 802, and RAM 803 are connected to each other via a bus 804. An input/output (I/O) interface 805 is also connected to the bus 804. 150. Multiple components in the electronic device 800 are connected to the I/O interface 805, including: an input unit 806, such as a keyboard, a mouse, etc.; an output unit 807, such as various types of displays, speakers, etc.; a storage unit 808, such as a disk, an optical disk, etc.; and a communication unit 809, such as a network card, a modem, a wireless communication transceiver, etc. The communication unit 809 allows the device 800 to exchange information/data with other devices through a computer network such as the Internet and/or various telecommunication networks. 151. The computing unit 801 can be various general and/or special processing components with processing and computing capabilities. Some examples of the computing unit 801 include, but are not limited to, a central processing unit (CPU), a graphics processing unit (GPU), various special artificial intelligence (AI) computing chips, various computing units running machine learning model algorithms, digital signal processors (DSPs), and any appropriate processors, controllers, microcontrollers, etc. The computing unit 801 performs the various methods and processes described above, such as the application running method. For example, in some embodiments, the application program execution method may be implemented as a computer software program, which is tangibly contained in a machine-readable medium, such as a storage unit 808. In some embodiments, part or all of the computer program may be loaded and/or installed on the device 800 via a ROM 802 and/or the communication unit 809. When the computer program is loaded into the RAM 803 and executed by the computing unit 801, one or more steps of the application program execution method described above may be performed. Alternatively, in other embodiments, the computing unit 801 may be configured to execute the application program execution method in any other appropriate manner (e.g., by means of firmware).

Various embodiments of systems and techniques described above herein can be implemented in digital electronic circuit systems, integrated circuit systems, field programmable gate arrays (FPGAs), application specific integrated circuits (ASICs), application specific standard products (ASSPs), system on chips (SOCs), complex programmable logic devices (CPLDs), computer hardware, firmware, software, and/or combinations thereof. These various embodiments may include: being implemented in one or more computer programs that can be executed and/or interpreted on a programmable system including at least one programmable processor, which may be a dedicated or general programmable processor that can receive data and instructions from a storage system, at least one input device, and at least one output device, and transmit data and instructions to the storage system, the at least one input device, and the at least one output device.

A program code for implementing methods of the present disclosure may be written in any combination of one or more programming languages. These program codes may be provided to a processor or controller of a general-purpose computer, a dedicated computer, or other programmable data processing device, so that when the program code is executed by the processor or controller, functions/operations specified in the flowchart and/or block diagram are implemented. The program code may be executed entirely on the machine, partially on the machine, partially on the machine and partially on a remote machine as a stand-alone software package, or entirely on a remote machine or server.

In the context of the present disclosure, the machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of a foregoing. More specific examples of machine-readable storage media would include electrical connections based on one or more wires, a portable computer disk, a hard disk, a RAM, a ROM, an erasable programmable read-only memory (EPROM or flash memory), optical fiber, a portable compact disk read-only memory (CD-ROM), an optical storage device, a magnetic storage device, or any suitable combination of the foregoing.

To provide interaction with a user, systems and techniques described herein may be implemented on a computer having: a display device (e.g., a cathode ray tube (CRT) or liquid crystal display (LCD) monitor) for displaying information to the user; and a keyboard and pointing device (e.g., a mouse or trackball) through which the user can provide input to the computer. Other types of devices may also be used to provide interaction with the user; for example, the feedback provided to the user may be any form of sensory feedback (e.g., visual feedback, auditory feedback, or tactile feedback); and the input from the user may be received in any form (including acoustic input, voice input, or tactile input).

Systems and techniques described herein may be implemented in a computing system that includes a backend component (e.g., as a data server), or a computing system that includes a middleware component (e.g., an application server), or a computing system that includes a frontend component (e.g., a user computer with a graphical user interface or a web browser through which the user can interact with an implementation of systems and techniques described herein), or a computing system that includes any combination of such backend components, middleware components, or frontend components. Components of the system can be interconnected by digital data communication in any form or medium (e.g., a communication network). Examples of communication networks include: a local area network (LAN), a wide area network (WAN), and the Internet.

A computer system may include a client and a server. The client and the server are generally remote from each other and usually interact through a communication network. The relationship between the client and the server is generated by computer programs running on corresponding computers and having a client-server relationship with each other. Among them, the server can be a cloud server, also known as a cloud computing server or a cloud host, which is a host product in the cloud computing service system to solve defects of difficult management and weak business scalability in traditional physical hosts and virtual private server (VPS). The server can also be a server of a distributed system, or a server combined with a blockchain.

It should be understood that various forms of processes shown above can be used to reorder, add or delete steps. For example, steps recorded in this disclosure can be executed in parallel, sequentially, or in different orders, as long as desired results of the technical solution disclosed in this disclosure can be achieved, and this document does not limit it here.

The above specific implementations do not constitute a limitation on a protection scope of the present disclosure. It should be understood by those skilled in the art that various modifications, combinations, sub-combinations, and substitutions may be made according to design requirements and other factors. Any modification, equivalent substitution, and improvement made within the spirit and principle of the present disclosure shall be included in the protection scope of the present disclosure.

What is claimed is:

1. A processing method applied to a first device, comprising:
obtaining first image information;
determining an image display area based on the first image information, an size of the image display area being larger than a size of a first image corresponding to the first image information, and an area of the image display area being smaller than or equal to a first screen of the first device; and
outputting a display image based on the image display area and the first image information, the display image including the first image.

2. The method according to claim 1, wherein determining the image display area based on the first image information comprises:
generating the first image based on the first image information;
generating a second image based on the first image, the second image being an image portion located at least on one side of the first image, and the second image and the first image satisfying a matching condition in shapes and sizes; and
forming the display image based on the first image and the second image, and determining the image display area based on the image size of the display image.

3. The method according to claim 2, wherein outputting the display image comprises:
outputting the first image in the first display area of the image display area;
based on a first display effect of the first image in the first area, determining a second display effect of the second image; and
outputting the second image with the second display effect in a second display area of the image display area, the second display area being an image display area on at least one side of the first display area.

4. The method according to claim 3, further comprising:
acquiring a target display parameter, the target display parameter being a parameter characterizing a display state of the second image; and
when the target display parameter satisfies a first condition, switching a second area of the second image to an invisible state.

5. The method according to claim 4, further comprising:
in response to a first target operation in the image display area, switching the second area of the second image from the invisible state to a visible state, the first target operation being an operation performed on the second image.

6. The method according to claim 2, wherein generating the second image based on the first image comprises:
determining a second width of the second image based on a first width of a target identifier, the target identifier being an indicator symbol that guides a user to perform the first target operation in the second image; and
obtaining a first image size of the first image, and determining a second image size of the second image based on the first image size and the second width.

7. The method according to claim 3, wherein obtaining the first image information comprises:
establishing a data channel with a second device, wherein the second device includes a second screen, and the first image information is image data displayed by the second screen; and
in response to a first target instruction, receiving the first image information of the second device based on the data channel.

8. The method according to claim 7, further comprising:
in response to a second target operation in the image display area, generating a second target instruction, wherein the second target operation is an operation of sliding from the second display area of the image display area into the first image, the second target instruction is configured to instruct the second device to simulate the second target operation on the second screen, and the second display area is the image display area on at least one side of the first image; and
sending the second target instruction to the second device based on the data channel.

9. The method according to claim 8, further comprising:
in a full screen mode, enlarging the first image in the image display area to cover the second display area;
in response to a third target operation in the image display area, generating a third target instruction, wherein the third target operation is an operation of sliding from the second display area covered by the first image into the first image, and the third target instruction is configured to instruct the second device to simulate the third target operation on the second screen; and
sending the third target instruction to the second device based on the data channel.

10. An electronic device comprising:
one or more processors; and a memory in communication with the one or more processors and containing instructions that, when being executed, cause the one or more processors to perform:
obtaining first image information;
determining an image display area based on the first image information, an size of the image display area being larger than a size of a first image corresponding to the first image information, and an area of the image display area being smaller than or equal to a first screen of the first device; and
outputting a display image based on the image display area and the first image information, the display image including the first image.

11. The device according to claim 10, wherein the one or more processors are further configured to perform:
generating the first image based on the first image information;
generating a second image based on the first image, the second image being an image portion located at least on one side of the first image, and the second image and the first image satisfying a matching condition in shapes and sizes; and
forming the display image based on the first image and the second image, and determining the image display area based on the image size of the display image.

12. The device according to claim 11, wherein the one or more processors are further configured to perform:
outputting the first image in the first display area of the image display area;
based on a first display effect of the first image in the first area, determining a second display effect of the second image; and
outputting the second image with the second display effect in a second display area of the image display area, the second display area being an image display area on at least one side of the first display area.

13. The device according to claim 12, wherein the one or more processors are further configured to perform:
acquiring a target display parameter, the target display parameter being a parameter characterizing a display state of the second image; and
when the target display parameter satisfies a first condition, switching a second area of the second image to an invisible state.

14. The device according to claim 13, wherein the one or more processors are further configured to perform:
in response to a first target operation in the image display area, switching the second area of the second image from the invisible state to a visible state, the first target operation being an operation performed on the second image.

15. The device according to claim 11, wherein the one or more processors are further configured to perform:
determining a second width of the second image based on a first width of a target identifier, the target identifier being an indicator symbol that guides a user to perform the first target operation in the second image; and
obtaining a first image size of the first image, and determining a second image size of the second image based on the first image size and the second width.

16. The device according to claim 12, wherein the one or more processors are further configured to perform:
establishing a data channel with a second device, wherein the second device includes a second screen, and the first image information is image data displayed by the second screen; and
in response to a first target instruction, receiving the first image information of the second device based on the data channel.

17. The device according to claim 16, wherein the one or more processors are further configured to perform:
in response to a second target operation in the image display area, generating a second target instruction, wherein the second target operation is an operation of sliding from the second display area of the image display area into the first image, the second target instruction is configured to instruct the second device to simulate the second target operation on the second screen, and the second display area is the image display area on at least one side of the first image; and
sending the second target instruction to the second device based on the data channel.

18. The device according to claim 17, wherein the one or more processors are further configured to perform:
in a full screen mode, enlarging the first image in the image display area to cover the second display area;
in response to a third target operation in the image display area, generating a third target instruction, wherein the third target operation is an operation of sliding from the second display area covered by the first image into the first image, and the third target instruction is configured to instruct the second device to simulate the third target operation on the second screen; and
sending the third target instruction to the second device based on the data channel.

19. A non-transitory computer readable storage medium containing instructions that, when being executed, cause at least one processor to perform:
obtaining first image information;
determining an image display area based on the first image information, an size of the image display area being larger than a size of a first image corresponding to the first image information, and an area of the image display area being smaller than or equal to a first screen of the first device; and
outputting a display image based on the image display area and the first image information, the display image including the first image.

20. The storage medium according to claim 19, wherein the at least one processor is further configured to perform:
generating the first image based on the first image information;
generating a second image based on the first image, the second image being an image portion located at least on one side of the first image, and the second image and the first image satisfying a matching condition in shapes and sizes; and
forming the display image based on the first image and the second image, and determining the image display area based on the image size of the display image.
